(19) United States
(12) Patent Application Publication
(10) Pub. No.: US 2012/0186993 A1
(43) Pub. Date: Jul. 26, 2012

(54) IONIC LIQUIDS

(75) Inventors: Junhua Huang, Mount Waverley (AU); Thomas Rüther, Ormond (AU); Paul Feron, Floraville (AU); Zhengbo Zhang, Wuhan (CN)

(73) Assignee: COMMONWEALTH SCIENTIFIC AND INDUSTRIAL RESEARCH ORGANISATION, Campbell, Australian Capital Territory (AU)

(21) Appl. No.: 13/387,574

(22) PCT Filed: Jul. 29, 2010
(86) PCT No.: PCT/AU2010/000960

§ 371 Date: Apr. 6, 2012

(30) Foreign Application Priority Data
Jul. 29, 2009 (AU) 2009903533

(51) Int. Cl. B01D 53/14; B01D 19/00

(52) U.S. Cl. 205/687; 95/236; 95/235; 95/232; 95/230; 95/241

(57) ABSTRACT

A process for the absorption of one or more gas(es) selected from the group consisting of carbon dioxide, hydrogen sulfide, sulfur oxides, nitrogen oxides and carbon monoxide from a fluid, the process including: providing a fluid containing the selected gas(es); and an ionic liquid absorbent, the absorbent including the components: one or more anions; one or more metal species; and optionally one or more organic cations; and optionally one or more ligands; the absorbent components being selected such that the absorbent is in a liquid state at the operating temperature and pressure of the process; with the provisos that: when the anion contains in the same molecular entity: both an amine functional group and a sulfonate functional group; both an amine functional group and a carboxylate functional group; both a phosphine functional group and a sulfonate functional group; or both a phosphine functional group and a carboxylate functional group, the metal species is not an alkali metal or alkaline earth metal; the anion and/or metal species do not form a cuprate; and when the anion and/or metal species form a metal halide, the ionic liquid absorbent includes one or more ligands; contacting the fluid with the ionic liquid absorbent such that the selected gas(es) interact with the metal species; and collecting an ionic liquid in which at least a portion of the selected gas(es) is absorbed.

### FIELD OF THE INVENTION

The invention relates to a process for the absorption of gases from fluids, such as flue gas streams and the like, using an absorbent, and a process for the desorption of gases from a gas-rich absorbent.

### BACKGROUND OF THE INVENTION

With the recognition of the environmental problems caused by atmospheric gas emissions, there is an increasing focus on developing or improving technologies involved in the capture of these gases.

Whilst several gases, including notably acid gases, carbon monoxide, and sulfur or nitrogen oxides, are known to present significant environmental problems, technology relating to the capture of carbon dioxide is of particular interest.

Chemical absorption may be used to remove CO₂ from gas streams (such as those derived from power plants). Currently, chemical absorption methods employing aqueous amine solutions or ammonia are used to capture CO₂. There are, however, a number of drawbacks in the use of aqueous amine solutions or ammonia as gas absorbents, including:
(1) intensive energy requirements for the desorption of CO₂ from the CO₂-enriched amine solution;
(2) corrosion of alloy steel pipes, pumps, etc by the amine absorbent;
(3) thermal or chemical degradation of the amine in the absorbent, producing extra waste streams and leading to loss of the active amine; and
(4) loss of volatile amines from the absorbent into the gas stream.

Ionic liquids are materials composed essentially of ions that generally exhibit a melting point below a temperature of about 150° C., but in some cases may be up to 250° C. Conventional molten salts typically display melting points in the order of several hundred degrees Celsius (eg, the melting point of sodium chloride (NaCl) is 801° C.). Ionic liquids possess several properties that render them suitable for use as gas absorbents, including:
(1) the energy requirements for desorption may also be lower than for amine solutions;
(2) ionic liquids are generally not corrosive;
(3) ionic liquids generally display thermal and chemical stability. The decomposition temperature of ionic liquids is normally above 250° C. Furthermore, ionic liquids are generally resistant to degradation by oxidative mechanisms, and to reaction with impurities; and
(4) with a few exceptions, ionic liquids are generally non-volatile and possess negligible vapour pressure. Accordingly, ionic liquids are generally non-flammable, and are expected to demonstrate minimal loss through evaporation into gas streams.

However, with conventional ionic liquids, absorption of CO₂ generally occurs through a physical absorption mechanism. This absorption mechanism essentially involves the dissolution of the gas into the ionic liquid without formation of chemical interactions between the dissolved gas and the ionic liquid solute molecules. This absorption mechanism leads to conventional ionic liquids demonstrating low CO₂ absorption capacities when the CO₂ partial pressure is at or below the ambient pressure conditions typically used in an industrial setting.

One approach addressing the low absorption capacity of ions liquids has been to design and develop so-called task-specific ionic liquids, bearing functional groups to introduce an additional chemical absorption mechanism. In this strategy, functional groups such as carboxylates, amines and amino acids are covalently incorporated into the structure of the constitutent cations or anions of the ionic liquid. Alternatively, ionic moieties may be covalently bound to polymers. However, both approaches require elaborate and time-consuming synthetic procedures to manufacture the constituent cations and/or anions of these task-specific ionic liquids.

Accordingly it is an object of the present invention to overcome, or at least alleviate one or more of the difficulties or deficiencies of the prior art.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

Accordingly, the present invention provides a process for the absorption of one or more gas(es) selected from the group consisting of carbon dioxide, hydrogen sulfide, sulfur oxides, nitrogen oxides and carbon monoxide from a fluid, the process including:
providing
   a fluid containing the selected gas(es); and
   an ionic liquid absorbent, the absorbent including the components:
      one or more anions;
      one or more metal species; and optionally
      one or more organic cations; and optionally
      one or more ligands;
   the absorbent components being selected such that the absorbent is in a liquid state at the operating temperature and pressure of the process;
      with the provisos that:
         when the anion contains in the same molecular entity: both an amine functional group and a sulfonate functional group; both an amine functional group and a carboxylate functional group; both a phosphine functional group and a sulfonate functional group; or both a phosphine functional group and a carboxylate functional group, the metal species is not an alkali metal or alkaline earth metal;
         the anion and/or metal species do not form a cuprate; and
         when the anion and/or metal species form a metal halide, the ionic liquid absorbent includes one or more ligands;
contacting the fluid with the ionic liquid absorbent such that the selected gas(es) interact with the metal species; and
collecting an ionic liquid in which at least a portion of the selected gas(es) is absorbed.

The present invention also provides a process for the desorption of gas from an ionic liquid in which one or more gas(es) selected from the group consisting of carbon dioxide, hydrogen sulfide, sulfur oxides, nitrogen oxides and carbon monoxide are absorbed, the process including:
providing an ionic liquid absorbent in which the one or more selected gas(es) are absorbed;
treating the ionic liquid absorbent in which the selected gas(es) are absorbed, such that the gas is released; and
collecting the released gas;
   wherein the ionic liquid absorbent including the components:
      one or more anions;
      one or more metal species; and optionally
      one or more organic cations; and optionally
      one or more ligands;
   the absorbent components being selected such that the absorbent is in a liquid state at the operating temperature and pressure of the process.
      with the provisos that:
         when the anion contains in the same molecular entity: both an amine functional group and a sulfonate functional group; both an amine functional group and a carboxylate functional group; both a phosphine functional group and a sulfonate functional group; or both a phosphine functional group and a carboxylate functional group, the metal species is not an alkali metal or alkaline earth metal;
         the anion and/or metal species do not form a cuprate; and
         when the anion and/or metal species form a metal halide, the ionic liquid absorbent includes one or more ligands.

### BRIEF DESCRIPTION OF THE DRAWINGS/FIGURES

FIG. 1 shows a flow-diagram example of a CO₂ absorption apparatus that may be employed in the process of one embodiment of the current invention.

FIG. 2 shows a graph of CO₂ absorption capacity (wt %) as a function of the CO₂ pressure for [EMIM][TFSI]-Zn(TFSI)₂ (1:1 mol:mol) at 40° C. (▴) and 60° C. (∇). CO₂ absorption capacities for pure [EMIM][TFSI] at 40° C. (∘) are included for comparison.

FIG. 3 shows CO₂ absorption capacity (wt %) as a function of the CO₂ pressure for [EMIM][TFSI] (∘), [EMIM][TFSI]-Co(TFSI)₂ (1:1 mol:mol) (▴), [EMIM][TFSI]-Ni(TFSI)₂ (1:1 mol:mol) (∇), [EMIM][TFSI]-Cu(TFSI)₂ (1:1 mol:mol) (⋄), [EMIM][TFSI]-Zn(TFSI)₂ (1:1 mol:mol) (▪) at 40° C., and [EMIM][TFSI]-Cd(TFSI)₂ (1:0.5 mol:mol) () at 60° C.

FIG. 4 shows CO₂ absorption capacity (wt %) as a function of the CO₂ pressure for [EMIM][TFSI] (∘), [EMIM][TFSI]-Mn(TFSI)₂ (1:0.3 mol:mol) ( [symbol] ), [EMIM][TFSI]-Fe(TFSI)₂ (1:0.5 mol:mol) (Δ) at 40° C.

FIG. 5 shows CO₂ absorption capacity (wt %) as a function of the CO₂ pressure for [EMIM][TFSI] (∘), [EMIM][TFSI]-Mg(TFSI)₂ (1:0.75 mol:mol) ( [symbol] ), [EMIM][TFSI]-Al(TFSI)₃ (1:1 mol:mol) (Δ) at 40° C.

FIG. 6 shows CO₂ absorption capacity (wt %) as a function of the CO₂ pressure for [EMIM][DCA] (∘) and [EMIM][DCA]-Zn(DCA)₂ (1:0.5 mol:mol) ( [symbol] ) at 40° C.

FIG. 7 shows CO₂ absorption capacity (wt %) as a function of the CO₂ pressure for [C₄mpyrr][TFSI] (∘) and [C₄mpyrr][TFSI]-Zn(TFSI)₂ (1:1 mol:mol) ( [symbol] ) at 40° C.

FIG. 8 shows a desorption curve for [EMIM][TFSI]-Zn(TFSI)₂ (1:1 mol:mol) at 77° C. and 8 mbar.

FIG. 9 shows CO₂ absorption capacity (wt %) as a function of the CO₂ pressure for [EMIM][OAc]-Zn(OAc)₂ (1:1 mol:mol) at 40° C. (∘) and at 90° C. ( [symbol] ).

FIG. 10 shows thermal gravimetric analysis data for [EMIM][TFSI]-Co(TFSI)₂ (1:1 mol:mol) (*), [EMIM][TFSI]-Ni(TFSI)₂ (1:1 mol:mol) (♦), [EMIM][TFSI]-Cu(TFSI)₂ (1:1 mol:mol) (⋄), [EMIM][TFSI]-Zn(TFSI)₂ (1:1 mol:mol) (▪).

### DETAILED DESCRIPTION OF THE EMBODIMENTS

It has been surprisingly discovered that the inclusion of a metal species in an ionic liquid absorbent may cause the absorbent to demonstrate a higher gas absorption capacity when compared to the absorption capacity of the ionic liquid alone.

Preferably, the interaction between the selected gas(es) and the metal species is the primary mechanism for absorption of the selected gas(es).

Without wishing to be bound by theory, it is believed that the inclusion of a metal species in an ionic liquid provides a chemical absorption mechanism which may operate in addition to a physical absorption mechanism for the absorption of gases. The chemical absorption mechanism may involve the reversible formation of a chemical interaction between the metal and the gas.

Moreover, it is believed that by altering of the electronic environment of the metal species through selection of the appropriate ionic liquid and/or selection of one or more appropriate metal complex ligands, the strength of the interaction between the metal species and the one or more selected gas(es) may be modified such that the interaction between the metal species and the absorbed gas(es) is stable under the operating conditions of a gas absorption process, and unstable under the operating conditions of the gas desorption process. By altering the strength of the interaction between the metal species and the absorbed gas(es), it is believed that the gas absorption and desorption processes may be made more efficient, as the energy input required to effect the desorption process may be minimised.

Alterations of the electronic environment of the metal may be achieved through coordination to the metal centre by one or more of (1) the anion component, (2) the organic cation component or (3) the ligand component, the presence of an organic cation and/or ligand depending on the particular embodiment of the invention. Formation of a coordination complex between the metal species and one or more of these components may directly affect the electronic configuration of the metal species. Alternatively, the electronic environment of the metal may be affected at a more macroscopic level by the overall electrostatic environment of the bulk ionic liquid absorbent.

The term “ionic liquid” as used throughout the specification refers to an ionic compound that possesses a melting point below a temperature of about 250° C. at atmospheric pressure, more preferably below about 200° C. at atmospheric pressure, and most preferably below about 150° C. at atmospheric pressure. Use of the term “ionic liquid” is not intended to exclude addition of other components or solvents into the ionic liquid. For example, the ionic liquid may include additional solvents such as water. The ionic liquid may also include additives that act as corrosion inhibitors or oxidation inhibitors.

As would be known by the person skilled in the art, the term “liquid state” as used herein refers to both a homogeneous composition and a suspension or dispersion.

The metal species in the ionic liquid absorbent may be dissolved in the ionic liquid, or suspended or dispersed in the ionic liquid.

The terms “interact”, “interacts” and “interaction”, as used throughout the specification refers to a reversible association between the selected gas(es) and the ionic liquid absorbent. The interaction may be in the form of, for example, a weak, non-covalent interaction between the selected gas(es) and the ionic liquid absorbent (for example, an electrostatic interaction or a Van der Waals interaction), a coordinate bond between the ionic liquid absorbent and the selected gas(es), or a covalent interaction between the ionic liquid absorbent and the selected gas(es). In other words, for the selected gas(es), involved in the absorption/desorption process, the gas(es) have the same chemical structure prior to absorption and after desorption. The absorption/desorption process is not intended to encompass a “conversion” process, where the selected gas(es) are absorbed and converted into a different species, the different species then being released from the ionic liquid.

The abbreviation “EMIM” as used throughout the specification refers to the 1-ethyl-3-methylimidazolium ion, the structure of which is illustrated in Scheme 1.

The abbreviation “C₄mpyrr” as used throughout the specification refers to the N-methyl, N-butyl pyrrolidinium ion, the structure of which is illustrated in Scheme 1.

The abbreviation “DCA” as used throughout the specification refers to the dicyanamide ion, the structure of which is illustrated in Scheme 1.

The abbreviation “TFSI” as used throughout the specification refers to the trifluoromethanesulfonimide anion, the structure of which is illustrated in Scheme 1. This anion is also known as a bis(trifluoromethanesulfonyl)imide anion.

The abbreviation “OAc” as used throughout the specification refers to the acetate ion.

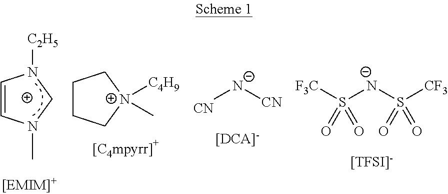

The gas(es) to be absorbed are selected from carbon dioxide, hydrogen sulfide, sulfur oxides (for instance SO₂ and SO₃), nitrogen oxides (for example NO, NO₂ and N₂O) and carbon monoxide. Preferably, the gas(es) is/are carbon dioxide, sulfur oxides and nitrogen oxides. Most preferably the gas is carbon dioxide.

The fluid from which the selected gas(es) is/are absorbed may be any fluid stream in which the separation of the selected gas(es) from the fluid is desired. Examples of fluids include product gas streams e.g. from coal gasification plants, reformers, pre-combustion gas streams, post-combustion gas streams such as flue gases, the exhaust streams from fossil-fuel burning power plants, sour natural gas, post-combustion emissions from incinerators, industrial gas streams, exhaust gas from vehicles, exhaust gas from sealed environments such as submarines and the like.

As stated above, the components of the ionic liquid according to the present invention are selected such that the ionic liquid absorbent is in a liquid state at the operating temperature and pressure of the process. Typically, the operating temperature may be from about −80° C. to about 350° C.; more preferably from about 20° C. to about 200° C.; most preferably between about 20° C. to about 180° C. The pressure used in the process may be from about 0.01 atm to about 150 atm; more preferably 1 to 70 atm; most preferably 1 to 30 atm.

The anionic component of the ionic liquid according to the first aspect of the present invention may include any anion known to the person skilled in the art so long as an ionic liquid is formed when the anion is present with the other components of the absorbent under the operating conditions of the process. The anion may be an inorganic or organic anion.

Preferably, the anion is selected from the group consisting of, but not limited to one or more of:

i) substituted amides or substituted imides; such as dicyanamide; such as alkyl or aryl sulfonamides and their fluorinated derivatives such as toluenesulfonamide, trifluoromethylsulfonamide and also their N-alkyl or aryl derivatives; alkyl and aryl sulfonimides and their substituted derivatives such as bis(phenylsulfonyl)imide and bis(trifluormethanesulfonyl)imide, bis(halosulfonyl)imides such as bis(fluorosulfonyl)imide; bis(halophosphoryl)imides such as bis(difluorophosphoryl)imide; mixed imides such as (trifluoromethanesulfonyl) (difluorophosphoryl)imide;
ii) stable carbanions; such as tricyanmethanide;
iii) tetrahaloborates; halides, cyanate; isocyanate; thiocyanate;
iv) inorganic nitrates, organic nitrates (such as alkyl or aryl nitrates) and nitrites;
v) oxysulfur species, including sulfates, which may be selected from the group consisting of but not limited to sulfate, hydrogen sulfate, alkyl or aryl sulfates esters, persulfate (SO₅²⁻), sulfite (SO₃²⁻), hyposulfite (SO₂²⁻), peroxydisulfite (S₂O₈²⁻),
viii) sulfonates selected from the group consisting of alkyl or aryl sulfonates, for example trifluoromethanesulfonate, pentafluoroethyl sulfonate, toluene-4-sulfonate, and their substituted or halogenated derivatives and/or alkyl substituted derivatives of aryl sulfonate;
vi) oxyphosphosphorus species which may be selected from the group consisting of: phosphate, hydrogen phosphate, dihydrogen phosphate, hexahalophosphates, optionally substituted and/or halogenated alkyl phosphate mono-, di- and triesters; optionally substituted and/or halogenated aryl phosphate mono-, di- and triesters; mixed substituted phosphate di- and triesters, mixed substituted phosphate di- and triesters; optionally substituted and/or halogenated alkyl phosphates; optionally substituted and/or halogenated aryl phosphates; halogen, alkyl or aryl mixed substituted phosphates, alkyl or aryl phosphonates, alkyl or aryl phosphinates, other oxoanion phosphates and metaphosphate;
vii) carbonates, hydrocarbonate, alkyl or aryl carbonates and other oxoanion carbonates;
ix) carboxylates which may be selected from the group consisting of, but not limited to, alkylcarboxylates, arylcarboxylates and ethylenediaminetetraacetate. Preferably, the alkylcarboxylates contain one, two or three carboxylate groups. Examples of alkylcarboxylates include acetate, propanoate, butanoate, pentanoate, hexanoate, heptanoate, octanoate, nonanoate, decanoate, oxalate, manolate, succinate, crotonate, fumarate; and their halogen substituted derivatives, such as trifluoroacetate, pentafluoropropanoate, heptafluorobutanoate. The alkyl group of the alkylcarboxylate may also be substituted with other substituent groups, such as in glycolate, lactate, tartrate, malate, citrate; deprotonated aminoacids such as histidine and derivatives thereof. When the carboxylate is an arylcarboxylate, the structure contains preferably one, two, or three carboxylate groups. Examples of preferred arylcarboxylates include benzoate, benezenedicarboxylate, benezenetricarboxylate, benzenetetracarboxylate, and their halogen-substituted derivatives such as chlorobenzoate, fluorobenzoate;
x) silicates and organosilicates;
xi) borates, such as tetracyanoborate, alky and aryl chelatoborates and their fluorinated derivatives such as bis(oxalate)borate (BOB), bis(1,2 phenyldiolato)borate, difluoro-monooxalato-borate, perfluoroalkyltrifluoroborate;
xi) alkyl boranes and aryl boranes and their fluorinated and cyanated derivatives such as tetra(trifluoromethyl)borane, perfluoroarylboranes, alkylcyanoboranes;
xii) deprotonated acidic heterocyclic compounds such as alkyl and aryl imidazoles and their fluorinated derivatives;
xiii) alkyloxy compounds and aryloxy compounds and their fluorinated derivatives such as methanolate, phenolate, and perfluorobutanoate;
xiv) alpha to omega diketonates; alpha to omega acetylketonates and their fluorinated derivatives such as acetylacetonate (acac), 1,1,1,5,5,5-hexafluoropentane-2,4-dione; and
xv) complex metal anions, such as complex halogen metalates or transition metalates [MₐX_{b}]^{t-} (eg. halogenozincate anions, a halogenocopper-(II) or -(I) anion, a halogenoiron-(II) or -(III) anion, X: ligands), halogenoaluminate anions, an organohalogenoaluminate anion, organometallic anions and mixtures thereof.

The anion may also be a “charge-diffuse” anion. Particularly preferred “charge diffuse” anions possess an electron withdrawing functional group in their structure that includes, but is not limited to, amide, imide, sulfate, sulfonate, phosphate, phosphonate, halogenide, cyanide, fluoroalkyl, aryl and fluoroaryl, carboxylate, carbonyl, borate, borane functional groups.

More preferably, the anion is selected from the group consisting of anions that are capable of forming the appropriate chemical environment surrounding the metal species, such that the resulting the metal species may reversibly form an interaction with the selected gas(es) under the operating condition of the process. Preferably, the anion is selected such that the interaction formed between the metal species and the selected gas(es) is stable during the process of gas absorption, and unstable during the process of gas desorption. Most preferably, the anion is bis(trifluoromethanesulfonyl)imide (TFSI).

Most preferably, the one or more anions may be selected from the group consisting of substituted amides; substituted imides, stable carbanions; hexahalophosphates; tetrahaloborates; halides; cyanate; isocyanate; thiocyanate; inorganic nitrates; organic nitrates; nitrites; oxysulfur species; sulfonates; oxyphosphorus species; optionally substituted and/or halogenated alkyl phosphate mono-, di- and triesters; optionally substituted and/or halogenated aryl phosphate mono-, di- and triesters; mixed substituted phosphate di- and triesters; optionally substituted and/or halogenated alkyl phosphates; optionally substituted and/or halogenated aryl phosphates; halogen, alkyl or aryl mixed substituted phosphates; carboxylates; carbonates; silicates; organosilicates; borates, alkyl boranes; aryl boranes; deprotonated acidic heterocyclic compounds; alkyloxy compounds; aryloxy compounds; alpha to omega diketonates; alpha to omega acetylketonates; and complex metal ions

The metal species in the ionic liquid absorbent may be dissolved in the ionic liquid, or suspended or dispersed in the ionic liquid.

The metal species may include one or more metals selected from the group consisting of 1a main-group metals (including Li through Cs), 2a main-group metals (including Be through Ba), 3a main-group metals (including B through TI), transition metals including scandium through zinc, yttrium through cadmium, hafnium through mercury, and rutherfordium through to the last known element, the lanthanides from lanthanum through lutetium, and the actinides from actinium through lawrencium, and the p-block metals germanium, tin, lead, antimony, bismuth and polonium.

Preferably, the metal species includes a metal selected from the metallic elements of row 2 to 6 of the periodic table. More preferably, the metal species includes a transition metal, a 2a main-group metal or a 3a main-group metal. Even more preferably, the metal species includes a metal selected from the group consisting of 2b-transition metals, 3d-transition metals, 4d-transition metals, 5d-transition metals, 2a main-group metals and 3a main-group metals. Most preferably, the metal species includes zinc, cadmium, mercury or aluminium.

The metal may be present in the absorbent in a molar ratio of from about 0.01 to about 10, where the molar ratio is defined as the number of moles of metal to the number of moles of anion. Preferably, the metal may be present in the absorbent in a molar ratio of from about 0.01 to about 5; most preferably the metal may be present in the absorbent in a molar ratio of from about 0.01 to about 1.

As will be appreciated by the skilled addressee, the ionic liquid absorbent may include more than one metal species and/or more than one anionic species. According to these embodiments, the number of moles of metal is expressed as the sum of the number of moles of all metal species in solution. Similarly, the number of moles of anion is expressed as the sum of the number of moles of all anionic species in the ionic liquid absorbent.

As would be understood by the person skilled in the art, the amount of a metal species included in an absorbent will depend upon several factors, including the atomic mass of the metal species, the absorption capacity of the metal species, the cost of the metal species, the solubility of the metal species in the ionic liquid, and the like.

The metal species may be charged or uncharged.

The metal species may be uncoordinated, or coordinated with one or more neutral or charged ligands. Preferably, the metal species is coordinated in such a way that the metal species can form a reversible interaction with the selected gas under the conditions of gas absorption and desorption.

The metal species may be introduced into the ionic liquid absorbent in the form of a metal-ligand complex. Alternatively, the metal species may form one or more metal-ligand complexes in situ. The metal species also may be introduced into the ionic liquid absorbent in the form of metal (0) particles.

The ligand may possess an overall neutral charge or alternatively possess an overall charge. The charged ligands may be either cationic or anionic in nature.

The neutral or charged ligands may be selected from those known to the person skilled in the art in coordination chemistry and/or organometallic chemistry, and include molecular species that possess one or more donor centres capable of forming a coordination bond with the metal species that is stable under the absorption conditions of the process according to the present invention. The donor centre capable of forming a coordination bond to the metal species may possess one or more electron lone pairs, or may possess π-electrons. Preferably, the ligand contains one or more donor centres selected from the group consisting of the main group V-VII elements that possess one or more electron lone pair(s), or contains π-electrons. Most preferably, the donor centre is an N, O, P or S atom that possesses at one or more electron lone pair(s), or contains π-electrons. In a preferred embodiment, the ligand possesses from one to four donor centres.

For example, where the ligand is a neutral ligand, the ligand may be selected from the group consisting of, but not limited to, alkyl (saturated and unsaturated) and/or aryl substituted ethers, crown ethers, amines, ethylendiamines, ethylentriamines, or the respective derivatives containing oxygen, nitrogen, sulphur, phosphorus, arsenic, and/or antimony donors; substituted pyridines, bipyridines, phenanthrolines, imidazoles, pyroles, oxazoles and other N-heterocycles commonly used in coordination chemistry; alkenes; alkynes; arenes; carbenes.

Where the ligand is an anionic ligand, the ligand may selected from those known to the person skilled in the art. For example, the ligand may be alkyl and aryl substituted cyclopentadienyl, or their fluorinated derivatives.

In one embodiment, the anion component of the ionic liquid absorbent may function as a ligand of the metal species. Suitable anions are described above.

Alternatively, where the ligand is a cationic ligand, the ligand may be selected from those known to the person skilled in the art. For example, the cationic ligand may be a bis-amine, where only one amine group is quarternarised (positively charged) so that the electron pair of the second amine group is still available for coordination. This concept also applies to all other groups capable of forming-onium cations like bis-phosphines, bis-arsines, bis-sulfides, or mixed species thereof.

In one embodiment, the organic cation component of the ionic liquid absorbent may function as a ligand of the metal species. Suitable cations are described below.

Preferred metal complexes according to the present invention include 2b-, 3d- or 4d-transition metals or 3a main-group metals, coordinated by neutral or charged ligands. Particularly preferred metal complexes according to the present invention include 2b-, 3d- or 4d-transition metals coordinated by oxygen, nitrogen and/or phosphorus donor ligands.

The organic cation component of the ionic liquid absorbent according to this aspect of the present invention may be any suitable type known to the person skilled in the art, so long as an ionic liquid is formed when the organic cation is present with the other components of the ionic liquid absorbent.

The organic cation may be cyclic or non-cyclic. It may be saturated or unsaturated. The organic cation may optionally contain one or more heteroatom(s).

In one embodiment, the organic cation may be selected from the group consisting of, but not limited to, boronium (R₂L′L″B⁺), carbocations (R₃C⁺), amidinium (RC(NR₂)₂⁺), guanidinium (C(NR₂)₃⁺), silylium (R₃Si⁺), ammonium (R₄N⁺), oxonium (R₃O⁺), phosphonium (R₄P⁺), arsonium (R₄As+), antimonium (R₄Sb+), sulfonium (R₃S⁺), selenonium (R₃Se⁺), iodonium (IR₂⁺) cations, and their substituted derivatives, wherein
R is independently selected from the group consisting of Y, YO—, YS—, Y₂N— or halogen;
Y is a monovalent organic radical or H; and
L′ and L″ are ligands that may be identical or different, wherein L′ and L″ possess a net overall charge of zero.

Preferably, Y is a monovalent organic radical with from 1 to 16 carbon atoms, and is selected from the group consisting of alkyl, alkenyl, oxaalkyl, oxaalkenyl, azaalkyl, azaalkenyl, aryl, alkylaryl, and their partially fluorinated or perfluorinated counterparts.

When R is a monovalent organic radical, it may be connected to another monovalent organic radical R, so as to form a ring system that includes the centre of formal positive charge as described above.

The ligands L′ and L″ may be selected from those known to the person skilled in the art in coordination chemistry and/or organometallic chemistry, and include molecular species that possess one or more donor centres capable of forming a coordination bond with the boronium entity that is stable under the operation conditions of the process according to the present invention. The donor centre capable of forming a coordination bond with the boronium entity may possess one or more electron lone pairs, or may possess π-electrons. Preferably, the ligands L′ and L″ contain one or more donor centres selected from the group consisting of the main group V-VII elements that possess one or more electron lone pair(s), or contain π-electrons. Most preferably, the donor centre is an N, O, P or S atom that possesses one or more electron lone pair(s), or contains π-electrons. When the ligands L′ and L″ contain more than one donor centre, the donor centres may be identical or different. For example, the same ligand L′ or L″ may contain both an O- and a N-donor centre. In one embodiment, the ligands L′ and L″ are donor centres of the same molecule entity (for example, L′ and L″ are part of a chelating ligand).

In addition, the organic cation may be an unsaturated heterocyclic cation, including, but not limited to, substituted and unsubstituted pyridiniums (C₅R₆N⁺), pyridaziniums, pyrimidiniums, pyraziniums, imidazoliums (C₃R₅N₂⁺), pyrazoliums, thiazoliums, triazoliums (C₂R₄N₃⁺), oxazoliums, and substituted and unsubstituted multi-ring system equivalents thereof and so forth. The unsaturated heterocyclic ring system may also form one or several constituents of an extended multi-ring system such as in benzofuranes, benzothiophenes, benzanellated azoles such as benzthiazole and benzoxazoles, diazabicyclo-[x,y,z]-undecene systems, indoles and iso-indoles, purines, quinolines, thiafulvalene, and the like.

The organic cation may be a saturated heterocyclic cation, such as substituted and unsubstituted pyrrolidinium, piperidiniums, piperaziniums, morpholiniums, azepaniums, imidazoliniums (C₃R₇N₂⁺), and substituted and unsubstituted multi-ring system equivalents thereof and the like. The saturated heterocyclic ring system may also form one or several constituents of an extended multi-ring system.

The organic cation may alternatively be a non-cyclic cation. The non-cyclic cation may contain a saturated or unsaturated carbon skeleton.

Preferably, the organic cation is a cyclic or non-cyclic organic cation that contains one or more heteroatom(s) selected from the non-metal elements of row 2 to 5 of the periodic table. More preferably, the organic cation is a cyclic or non-cyclic organic cation that contains at least one heteroatom selected from B, N, O, Si, P, and S. Most preferably, the organic cation is a cyclic or non-cyclic organic cations that contains at least one heteroatom selected from B, N, P, and S.

It will be understood by the skilled addressee that if the metal species combined with the component(s) of anion(s) and/or ligand(s) forms an ionic liquid absorbent, it may not be necessary to include an organic cationic species. However, it will also be understood that, to maintain electrical neutrality of the ionic liquid absorbent, it may be necessary in certain embodiments to include an organic cation species. In those embodiments where it is not necessary to include an organic cation species to maintain electrical neutrality of the ionic liquid absorbent, it may still be desirable to include an organic cation species.

The ionic liquid absorbent may optionally include further solvents, surfactants or additives.

The ionic liquid absorbent may optionally include one or more solvents that are miscible with the ionic liquid absorbent. Suitable solvents depend upon the specific ionic liquid absorbent employed and would be known by the skilled person. If one or more solvents are included in the ionic liquid absorbent, the solvents may be included in an amount of from about 0.01 to about 50% (w/w), based upon the total weight of the ionic liquid absorbent. Preferably, the solvents are included in an amount of from 0.1 to about 50%; more preferably, an amount of from about 0.1 to about 30%.

Optionally, corrosion inhibitors, scale inhibitors, antifoam agents, antioxidants and other additives known to the person skilled in the art that may assist in the gas absorption or desorption processes of the present invention may be employed.

The ionic liquid absorbent may be prepared according to conventional methods. For example, the ionic liquid absorbents may be prepared by physically mixing metal-containing precursors into conventional ionic liquids, and is exemplified in the accompanying examples.

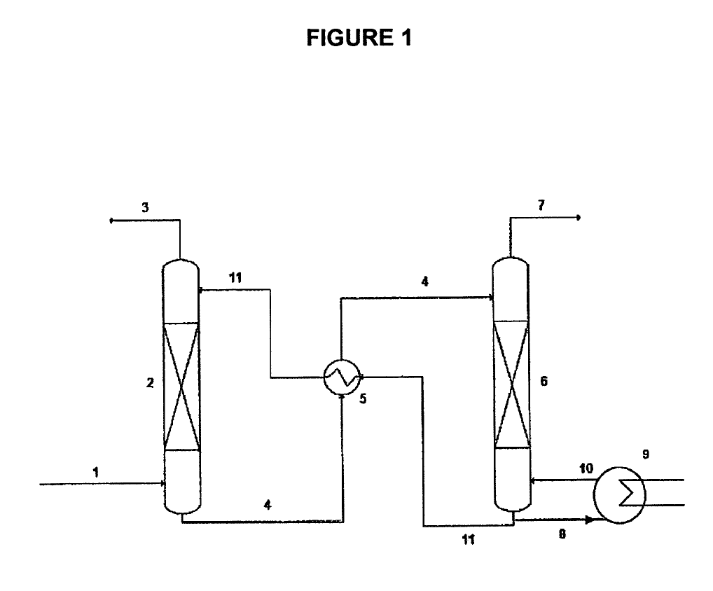

The processes of gas absorption and desorption according to the present invention may be carried out in any conventional equipment for the removal of gas from fluids by reactive chemical absorption and detailed procedures are well known to a person of ordinary skill in the art. See, for example, the flow-diagram of FIG. 1 or, S. A. Newman, Acid and Sour Gas Treating Processes, Gulf Publishing Company, Texas, 1995.

In one embodiment, the process of gas absorption and desorption may involve a gas separation process. Gas separation processes may be carried out according to methods known to persons skilled in the art, and may include, for example, the use of a membrane. According to this embodiment, the ionic liquid absorbent may be immobilized on a support such as a polymer to form a supported ionic liquid membrane.

Set out below is an example of a process that may be used in the process according to the present invention. This process is not intended to be limiting, and the person skilled in the art will recognise that the equipment and the operating conditions (for example, temperature and pressure) described may be altered depending upon both the nature of the ionic liquid absorbent employed in the absorption and desorption processes, and the gas(es) intended to be absorbed. In the embodiment described by FIG. 1, which is relevant to at least the processes of CO₂ absorption and desorption, the equipment comprises an absorber column 2, a heat exchanger 5, a desorber column 6 and a reboiler 9. Flue gas, which typically comprises 10 to 15% CO₂, is optionally passed through a prescrubber and then passes through conduit 1 to the packed absorber column 2, where it is contacted with the ionic liquid absorbent of the present invention. CO₂-lean flue gas is released from the top of the absorber via conduit 3, where it is collected or otherwise disposed of in accordance with processes known to those skilled in the art.

The pressure and temperature conditions in the absorber column 2 are typically 1 atm and about 40 to about 60° C. for conventional amine absorption technology. However, depending upon the specific ionic liquid absorbent employed in the absorption process, the absorption process may be carried out at an operating temperature. in the absorber column of, for example, between about −50° C. to about 350° C., preferably, between about −30° C. to about 200° C.; more preferably between about 20° C. to about 200° C. and most preferably between about 20° C. to about 180° C.

Again, depending upon the specific ionic liquid employed in the absorption process, the operating pressure in the absorber column may be between about 1 atm and 150 atm; preferably between about 1 atm and about 70 atm and most preferably between about 1 atm and 30 atm.

The processes according to the present invention may be conveniently carried out in any suitable absorber column. The great number of absorber columns used for gas purification operations include packed, plate or spray towers. These absorber columns are interchangeable to a considerable extent although certain specific conditions may favour one over the other. In addition to conventional packed, plate or spray towers, specialised absorber towers have been developed to meet specific process requirements. Examples of these specific towers include impingement-plate scrubbers turbulent contact scrubbers and membrane contactors. The absorber column used in the present invention may also contain other peripheral equipment as necessary for optimal process operation. Such peripheral equipment may include, but is not limited to, an inlet gas separator, a treated gas coalescor, a solvent flash tank, a particulate filter and a carbon bed purifier. The inlet gas flow rate varies according to the size of the equipment but is typically between 5 000 and 25 000 cubic metres per second. The solvent circulation rate is typically between 10 and 40 cubic metres per tonne of CO₂.

Desorption of the gas from the ionic liquid absorbent in which the selected gas(es) are absorbed may be effected by means of treating the gas-enriched ionic liquid absorbent using conventional methods and apparatus known to those skilled in the art. By way of non-limiting example, desorption of the gas from the ionic liquid absorbent in which the selected gas(es) are absorbed may occur by means of heating the gas-enriched ionic liquid absorbent, preferably in a desorber column. With reference to FIG. 1, the CO₂-rich ionic liquid absorbent is conducted through a pipe 4 to a desorber column 6 via a heat exchanger 5. In the desorber column 6, the CO₂-rich ionic liquid absorbent is heated to reverse the absorption reaction. CO₂ and moisture is collected from the top of the desorber column via conduit 7. The desorber column is heated by means of a reboiler 9, connected to the desorber by conduits 8 and 10. The heat source of the reboiler is preferably low pressure steam. The CO₂-lean ionic liquid absorbent is then conducted through a pipe 11 to the absorber 2 via the heat exchanger 5. In the heat exchanger 5, sensible heat from the lean ionic liquid composition is used to heat the CO₂-rich solution from the absorber.

Typical pressure and temperature conditions in the desorber in the embodiment described in FIG. 1 are about 1-5 atm and 100° C. to 150° C. Preferably, the desorber is heated using low pressure steam at a temperature of 105-135° C. as the heat source from the reboiler.

It will again be recognised by the person skilled in the art that the temperature and pressure conditions described in the preceding paragraph are relevant to conventional amine absorption technology, and that a broader range of desorption conditions may be used in the process according to the present invention, depending upon the specific ionic liquid used. For example, the desorption process may be carried out by heating the CO₂-rich absorbent at temperatures of between about 20° C. and 350° C. More preferably, the desorption process may be carried out between 40° C. and 200° C.; most preferably, between 40° C. and 180° C.

In another embodiment, CO₂-rich absorbent is treated by subjecting it to reduced pressure conditions. By “reduced pressure conditions”, the person skilled in the art will understand that the pressure conditions are reduced relative to the pressure conditions of the gas absorption process. The pressure conditions required to effect desorption are known to those skilled in the art and will depend upon the properties of the ionic liquid absorbent. Such properties include, by way of non-limiting example, the strength of the interaction formed between the ionic liquid absorbent and the absorbed CO₂ molecule. Typically, the pressure will be reduced from the operating pressure of the absorption process to between about 0.01 atm and 100 atm; preferably the pressure will be reduced to between about 0.1 atm and 10 atm and most preferably the pressure will be reduced to between about 0.1 atm and 2 atm.

In another embodiment, the desorber column may include membrane contactors. The person skilled in the art will understand that the choice of the membrane and the operational conditions will depend upon the properties of the ionic liquid absorbent.

It will be understood that a combination of both temperature and pressure may be used to effect desorption of CO₂ from a CO₂-rich ionic liquid absorbent. By way of non-limiting example, the CO₂-rich absorbent may be treated using a combination of both reduced pressure and heating to facilitate CO₂ desorption.

In another embodiment according to the present invention, the CO₂-rich ionic liquid absorbent may be treated by cooling the CO₂-rich absorbent, or allowing the CO₂-rich absorbent to cool, to a temperature below the melting point of the ionic liquid absorbent, such that the ionic liquid absorbent solidifies. Without wishing to be bound by theory, it is believed that once the CO₂-rich ionic liquid absorbent solidifies, the interaction between the ionic liquid absorbent and the selected gas(es) is disrupted, facilitating desorption of the absorbed gas. It will be recognised by the skilled addressee that the temperature at which the phase transition from liquid to solid occurs will depend upon the nature of the ionic liquid absorbent. Typically, the temperature of the ionic liquid absorbents according to the present invention be reduced, or allowed to reduce to a temperature of between about 1 to about 150° C. below the melting point of the ionic liquid absorbent, more preferably between about 1 to about 50° C. below the melting point of the ionic liquid absorbent, and most preferably between about 1 to about 20° C. below the melting point of the ionic liquid absorbent. Typical melting points of the ionic liquid contemplated by the present invention are known to those of skill in the art and may be in the range of around −50° C. to 250° C.

Again, without wishing to be bound by theory, it is believed that cooling the ionic liquid absorbent represents a particularly advantageous method of carrying out desorption, as it is anticipated that the energy requirements associated with cooling the ionic liquid absorbent will be relatively minor. As will be appreciated by the skilled addressee, one of the major problems associated with current amine absorption technology is the intensive energy input required to cause desorption of CO₂ from the CO₂-rich amine solution.

In another embodiment, the CO₂-rich absorbent may be treated by subjecting it to an electrochemical treatment. By “electrochemical treatment” the person skilled in the art will understand that an electrochemical potential is applied to a CO₂-rich ionic liquid absorbent through electrode(s) such that the oxidation state (or the electron configuration) of the absorption site is changed, and that the interaction between the ionic liquid absorbent and the absorbed CO₂ gas is disrupted, facilitating desorption of the absorbed gas. It will be recognised that the person skilled in the art that the potential will depend on the nature of the ionic liquid absorbent. The potential may be between −3.2 V to 2.0 V vs a standard hydrogen electrode.

In yet another embodiment, the absorbed CO₂ is desorbed by contacting the CO₂-rich ionic liquid absorbent with a fluid containing a condensable strip gas. Condensable strip gases suitable for this process are known to those skilled in the art, for example steam (water vapour). In one embodiment, the CO₂-rich ionic liquid absorbent is contacted with a fluid containing a condensable strip gas in a process known as flashing. Briefly, the CO₂-rich ionic liquid absorbent is contacted with a counter stream of a condensable strip gas. Suitable apparatus for desorption of gas by flashing are known to those of skill in the art and may include, for example, a flashing column. Operating conditions, including but not limited to flow rates, temperature and pressure may be readily determined by the person skilled in the art and will depend upon, for example, the nature of the ionic liquid absorbent and the apparatus in which the desorption process occurs.

The CO₂ absorption and desorption processes may either be carried out synchronously or alternatively the absorption and desorption processes may be carried out as discrete steps or stages. For example, the absorption process may occur at the site of CO₂ emission, for example at an industrial site. After the absorption process has been carried out, the CO₂-rich absorbent may then be transported from the emission site by conventional methods to a treatment facility, where the desorption process is carried out. For example, desorption treatment facilities may be located near a site for geosequestration of CO₂, whilst the site of CO₂ absorption may be geographically distant from this location.

It will be understood that the invention disclosed and defined in this specification extends to all alternative combinations of two or more of the individual features mentioned or evident from the text or drawings. All of these different combinations constitute various alternative aspects of the invention.

The following examples are intended to illustrate but not limit the present invention:

### EXAMPLES

### Example 1

### [EMIM][TFSI] Containing Transition Metal

Synthesis of Metal bis(trifluoromethanesulfonyl)imide Hydrate M(TFSI)₂.×(hydrate) (M=Co, Cu, Ni, Zn)

Metal bis(trifluoromethanesulfonyl)imides were synthesized by the methods of Earle, M. J. et al. (Earle, M. J. et al, Chem. Commun. 2004, 1368-1369; Earle, M. J. WO 200272260). 0.02 mol HNTf₂ was dissolved in 20 mL deionized water and then 0.01 mol metal hydroxide M(OH)₂ (M=Cu, Co, Ni) was added to this solution. After the suspension was stirred for ˜24 hours at room temperature, water was removed in vacuo at 40° C. The obtained products were dried under high vacuum at 60° C. for at least 24 hours. Hydrated products were obtained with yields between 89%-92%.

To a solution of HNTf₂.1.25 H₂O (6 g, 19.76 mmol) in 30 mL deionised water was added zinc metal (clumps) (1.94 g, 29.64 mmol). The suspension was stirred at room temperature for 24 h, after which the pH was 7. The reaction was filtered and the volatile components of the filtrate were removed in vacuo. The product was further dried under vacuum at 150° C. overnight yielding a white solid (5.45 g, 90%). The zinc content was found to be 9.45% by ICP-OES (calc. 10.45%). ¹⁹F NMR 200 MHz(DMSO-d₆): δ-79.17.

For M=Co, Cu, Ni, x was estimated to be 2-4 by Karl Fischer measurements; For M=Zn, x was estimated to be ≈0.2 by Karl Fischer measurement.

Preparation of Metal Ion Containing ILs [EMIM][TFSI]-M(TFSI)₂ (1:1 mol:mol) (M=Co, Ni, Cu, Zn)

Equal molar amounts of [EMIM][TFSI] and M(TFSI)₂.xH₂O were mixed and subsequently stirred at 70° C. under vacuum for about 48 hours. The water content of the thus obtained metal ion containing ILs was below the detection limit of the Karl Fischer measurements.

Synthesis of Iron (II) bis(trifluoromethanesulfonyl)imide pentahydrate

To a solution of HNTf₂.1.25 H₂O (3.0 g, 9.88 mmol) in 30 mL deionised water was added powdered iron metal (1.5 g, 26.9 mmol). The suspension was stirred at room temperature for 72 h, after which the pH was 7. The reaction was filtered and the volatile components of the filtrate were removed in vacuo. The product was further dried under vacuum at 75° C. overnight yielding a white solid with a bluish tinge (3.10 g, 89% for Fe(TFSI)₂.5H₂O). The product was found to have 5 equivalents of water as determined by Karl-Fischer titration. The iron content was found to be 7.55% by ICP-OES (calc. 7.91%). ¹⁹F NMR 200 MHz (DMSO-d₆): δ-79.20. MS (ESI, MeOH) −280.3.

Preparation of Iron (II) containing IL [EMIM][TFSI]-Fe(TFSI)₂ (1:0.5 mol:mol)

To a round bottom flask was added iron (II) bis(trifluoromethanesulfonyl)imide (0.353 g, 0.50 mmol) and 1-ethyl-3-methyl imidazolium bis(trifluoromethanesulfonyl)imide (0.39 g, 1.0 mmol). The mixture was stirred and placed under high vacuum at 75° C. for 72 h. The resultant product was a clear viscous oil.

Synthesis of Manganese (II) bis(trifluoromethanesulfonyl)imide

To a solution of HNTf₂.1.7 H₂O (4.56 g, 14.6 mmol) in 25 mL deionised water was added powdered manganese carbonate (1.11 g, 9.7 mmol). The reaction bubbled as CO₂ was evolved. The reaction was stirred at room temperature for 40 min, after which the pH was 7. The excess manganese carbonate was filtered and the volatile components of the filtrate were removed in vacuo. The product was further dried under vacuum at 150° C. overnight yielding a white solid (4.22 g, 94%). The product was found to have ˜0.02 equivalents of water as determined by Karl-Fischer titration. The manganese content was found to be 8.3% by ICP-OES (calc. 8.9%). ¹⁹F NMR 200 MHz (DMSO-d₆): δ-79.12. MS (ESI, MeOH)−280.2.

Preparation of Manganese (II) containing IL [EMIM][TFSI]-Mn(TFSI)₂ (1:0.3 mol:mol)

To a round bottom flask was added manganese bis(trifluoromethanesulfonyl)imide (0.50 g, 0.8 mmol) and 1-ethyl-3-methyl imidazolium bis(trifluoromethanesulfonyl)imide (0.954 g, 2.44 mmol). The mixture was stirred and placed under high vacuum at 75° C. for 48 h. The resultant product was a clear viscous oil.

Synthesis of Cadmium (II) bis(trifluoromethanesulfonyl)imide

To a solution of HNTf₂. 1.25H₂O (2.0 g, 6.59 mmol) in 5 mL deionised water was added cadmium carbonate (0.568 g, 3.29 mmol). The reaction bubbled as CO₂ was evolved. The reaction was stirred at room temperature for 2.75 h. The reaction mixture was filtered to remove particulates and the volatile components of the filtrate were removed in vacuo. The product was further dried under vacuum at 150° C. overnight yielding a white solid (2.16 g, 97%). The product was found to have 0.22 equivalents of water as determined by Karl-Fischer titration. The cadmium content was found to be 16.6% by ICP-OES (calc. 16.6%). ¹⁹F NMR 200 MHz(DMSO-d₆): δ-79.20. MS (ESI, MeOH)−280.2.

Preparation of Cadmium (II) containing IL [EMIM][TFSI]-Cd(TFSI)₂ (1:0.5 mol:mol)

To a round bottom flask was added cadmium bis(trifluoromethanesulfonyl)imide (0.61 g, 0.91 mmol) and 1-ethyl-3-methyl imidazolium bis(trifluoromethanesulfonyl)imide (0.71 g, 1.82 mmol). The mixture was dissolved in dichloromethane (5 mL) and stirred at room temperature for 15 min. The dichloromethane was removed in vacuo and the residue was placed under high vacuum at 75° C. for 16 h. The resultant product was a clear viscous oil at 75 ° C.; however, it became solidified on standing at room temperature. MS (ESI, MeOH)−280.2.

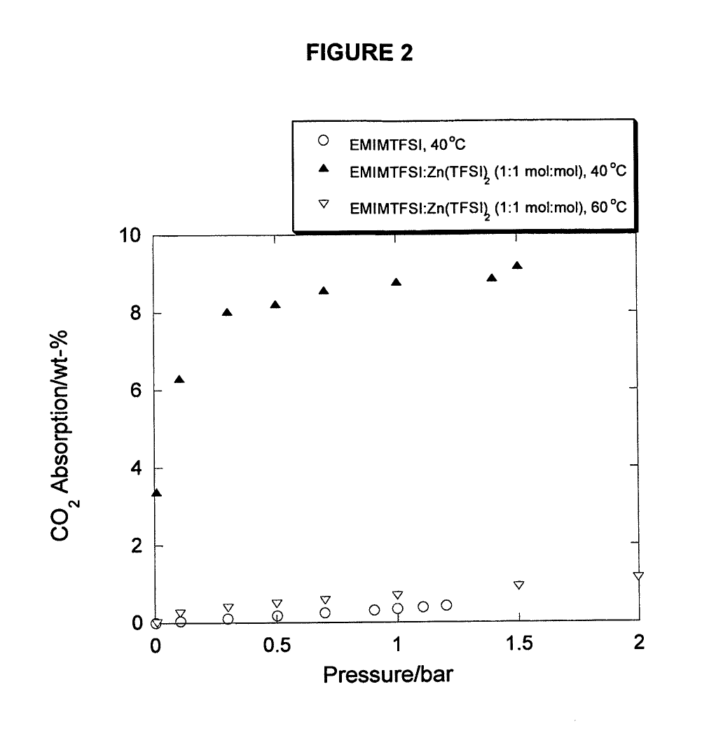

FIG. 2 shows that for the pure [EMIM][TFSI], the absorption at 40° C. displays a linear absorption behaviour with pressure, indicating a physical absorption mechanism. The absorption capacity at 1 bar is 0.35 wt %. Adding 6.4 wt % Zn²⁺ ([EMIM]⁺:Zn²⁺=1:1 mol/mol) to the IL leads to a different shape of the absorption curve. The absorption shows a steep increase at 0.1 bar and followed by a convex shape upon increasing the pressure. This convex-shaped absorption curve indicates a chemical absorption behaviour. At 1 bar, the absorption capacities are 8.8 and 0.7 wt % at 40° C. and 60° C., respectively. Introducing 6.4 wt % Zn²⁺ ions into [EMIM][TFSI] increases the CO₂ absorption capacity by 25 times at 40° C. compared to the pure IL.

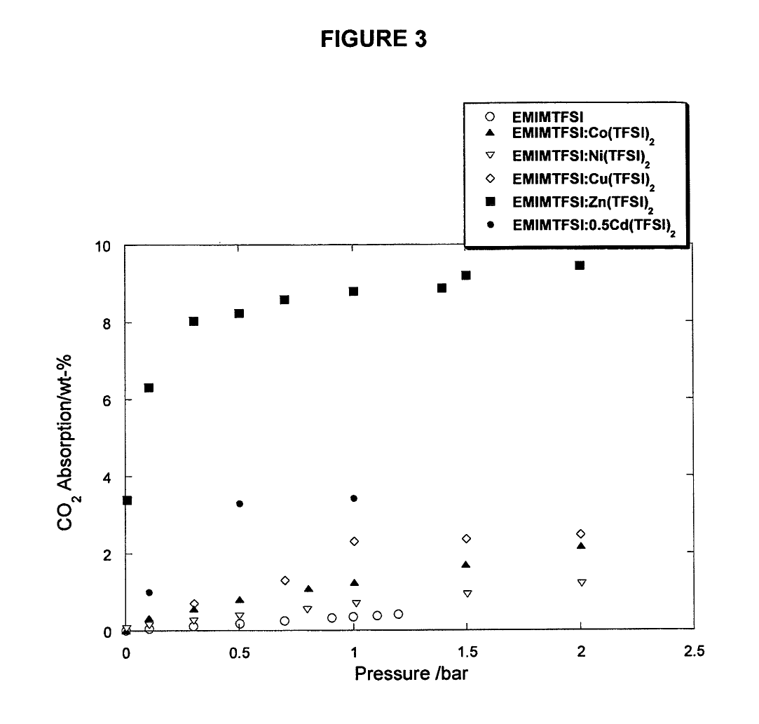

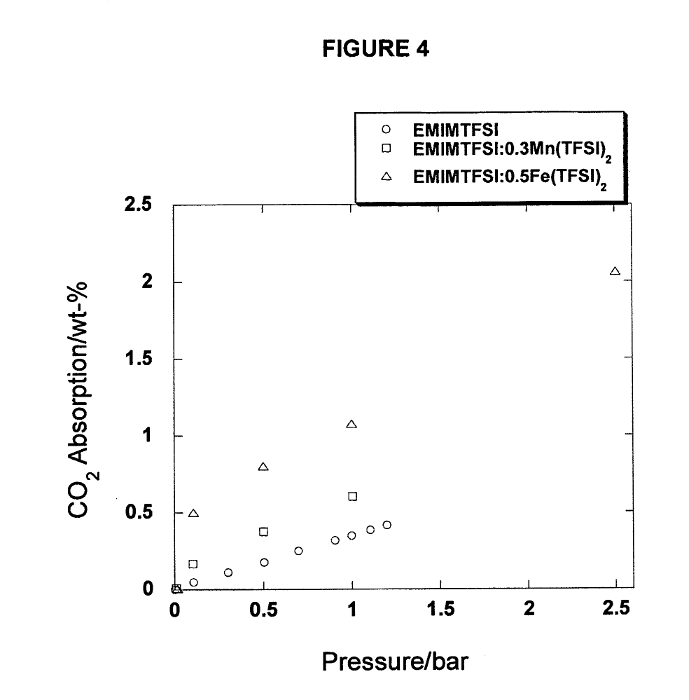

FIG. 3 and FIG. 4 show the effects of other transition metal of Mn, Fe, Co, Ni, Cu and Cd. Adding 6.3 wt % Cu²⁺ ([EMIM]⁺:Cu²⁺=1:1 mol/mol)) to the IL also leads to an increase in the CO₂ absorption capacity to 2.3 wt % at 1 bar, 6.6 times of that of pure [EMIM][TFSI]. The CO₂ absorption shows a steep increase in the pressure range below 1 bar, and a saturated absorption close to 2.5 wt % in the pressure range above 1 bar, again, suggesting a chemical absorption behaviour. Similarly, adding 3.1 wt % Mn²⁺ ([EMIM]⁺:Mn²⁺=3:1 mol/mol), 4.0 wt % Fe²⁺ ([EMIM]⁺:Fe²⁺=2:1 mol/mol), 5.8 wt % Co²⁺ ([EMIM]⁺:Co²⁺=1:1 mol/mol) or Ni²⁺ ([EMIM]⁺:Ni²⁺=1:1 mol/mol) increases the CO₂ absorption capacity to 0.6 wt %, 1.1 wt %, 1.23 wt % and 0.7 wt %, respectively, at 1 bar, 40° C. The effect of Cd²⁺ was measured at 60° C. Adding 7.7 wt % Cd^{2+ ([EMIM]}⁺:Cd²⁺=2:1 mol/mol) shows a CO₂ absorption capacity of 3.4 wt % at 60° C. In comparison, the CO₂ absorption capacity for pure [EMIM][TFSI] is only 0.27 wt % at 60° C.

### Example 2

### [EMIM][TFSI] Containing Main-Group Metal

Synthesis of Magnesium (II) bis(trifluoromethanesulfonyl)imide

To a solution of HNTf₂.1.25H₂O (2.0 g, 6.59 mmol) in 10 mL deionised water was added magnesium turnings (0.08 g, 3.29 mmol). The reaction bubbled as H₂ was evolved. The reaction was stirred at room temperature for 10 h, after which the pH was 7. The reaction mixture was filtered to remove particulates and the volatile components of the filtrate were removed in vacuo. The product was further dried under vacuum at 150° C. overnight yielding a white solid (1.61, 84%). The product was found to have 0.09 equivalents of water as determined by Karl-Fischer titration. The magnesium content was found to be 4.23% by ICP-OES (calc. 4.15%). ¹⁹F NMR 200 MHz (DMSO-d₆): δ-79.18. MS (ESI, MeOH)−280.2.

Preparation of Magnesium (II) containing IL [EMIM][TFSI]-Mg(TFSI)₂ (4:3 mol:mol)

To a round bottom flask was added magnesium bis(trifluoromethanesulfonyl)imide (0.75 g, 1.28 mmol) and 1-ethyl-3-methyl imidazolium bis(trifluoromethanesulfonyl)imide (0.67 g, 1.71 mmol). The mixture was stirred under high vacuum at 75° C. for 16 h. The product was a clear viscous oil. Mass (ESI)−280.3.

Synthesis of Aluminium (III) bis(trifluoromethanesulfonyl)imide

Aluminium (III) bis(trifluoromethanesulfonyl)imide was prepared according to the method described by Rocher et. al. (Rocher, N. M.; Izgorodina, E. I.; Ruether, T.; Forsyth, M.; MacFarlane, D. R.; Rodopoulos, T.; Home, M. D.; Bond, A. M. Chem. Eur. J. 2009, 15, 3435-3447). In a round bottomed flask equipped with a stir bar and a gas connection tap, under an argon atmosphere, neat AlCl₃ (0.150 g, 1.13 mmol) was added to a solution of HNTf₂(0.949 g, 3.38 mmol) in freshly distilled toluene (3 mL). The suspension became immediately bright yellow and this colour faded again within a few minutes while a clear liquid started to separate. Gas evolution (HCl) was observed and the vessel was occasionally evacuated to remove HCl from the reaction equilibrium.

After every evacuation, the argon atmosphere was replenished. Upon allowing the reaction mixture to stand for five days the liquid had solidified at ambient temperature. The supernatant was decanted, the remaining solid was washed with hexanes (3×2 mL) and the product dried under high vacuum at 40° C. to yield a white solid (0.50 g, 51%). Elemental analysis calc. (%) for C₆F₁₈N₃O₁₂S₆Al: 8.31, H, 0.00; N, 4.84; F, 39.42; found. C, 7.94; H, 0.16; N, 5.15; F 38.95. M.p. 53.6° C. (DSC). ¹⁹F NMR 200 MHz (DMSO-d₆): δ-79.12.

Preparation of Aluminium (III) containing IL [EMIM][TFSI]-AI(TFSI)₃ (1:1 mol:mol)

To a round bottom flask was added aluminium (III) bis(trifluoromethanesulfonyl)imide (0.311 g, 0.36 mmol) and 1-ethyl-3-methyl imidazolium bis(trifluoromethanesulfonyl)imide (0.140 g, 0.36 mmol). The mixture was stirred and placed under high vacuum at 70° C. for 24 h. The resultant product was a clear viscous oil. T_{g}=−63.8° C. (DSC). T_{dec}=94.2° C. (TGA).

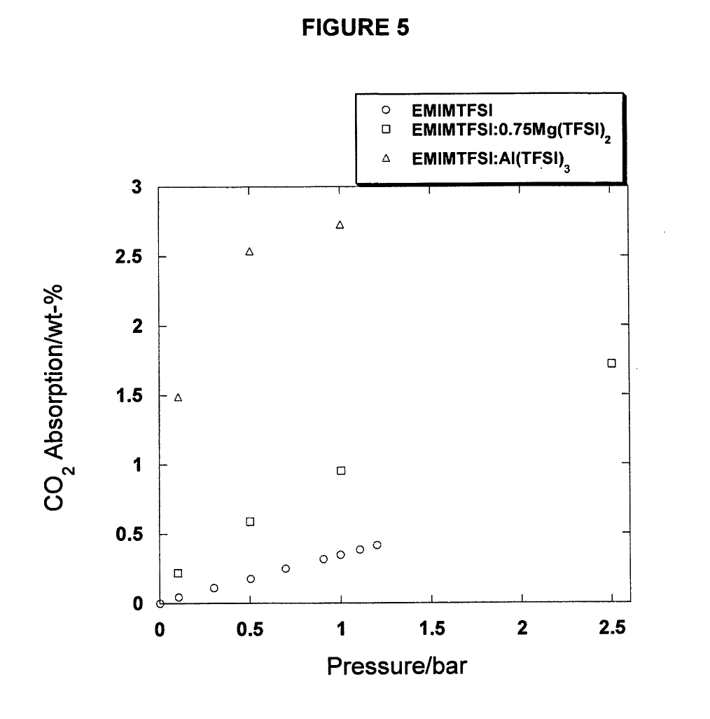

The effect of the main-group metal species on the CO₂ absorption is shown in FIG. 5. Adding 2.2 wt % Mg²⁺ ([EMIM]⁺: Mg²⁺=4:3 mol/mol) or 2.1 wt % Al^{3+ ([EMIM]}⁺: Al³⁺=1:1 mol/mol) into [EMIM][TFSI] increases the CO₂ absorption capacity to 1.0 wt % and 2.7 wt %, respectively, at 40° C., 1 bar.

### Example 3

### [EMIM][DCA] containing Zn²⁺

### Synthesis of Zinc Dicyanamide

Zinc dicyanamide was prepared using a method similar to that of Manson, J. L et al (Manson, J. L.; Lee, D. W.; Rheingold, A. L.; Miller, J. S. Inorg. Chem. 1998, 37, 5966-5967). A solution of sodium dicyanamide (2.0 g, 22.46 mmol) in deionised water (80 mL) was added to a stirring solution and zinc nitrate hexahydrate (3.34 g, 11.23 mmol) in deionised water (40 mL). The reaction was stirred at room temperature for 16 h after which, the reaction was filtered and the precipitate was washed with deionised water. The precipitate was placed under vacuum and over phosphorous pentoxide overnight to dry. The product was a white solid (1.63 g, 76%). The melting point is above 300° C. (DSC).

Preparation of Zinc (II) containing IL [EMIM][DCA]-Zn(DCA)₂ (1:0.5 mol:mol)

To a round bottom flask containing 1-ethyl-3-methylimidazolium dicyanamide (0.448 g, 2.53 mmol) was added zinc dicyanamide (0.250 g, 1.26 mmol). The mixture was stirred and heated to 75° C. until all of the zinc dicyanamide was dissolved. The product was a clear yellow oil.

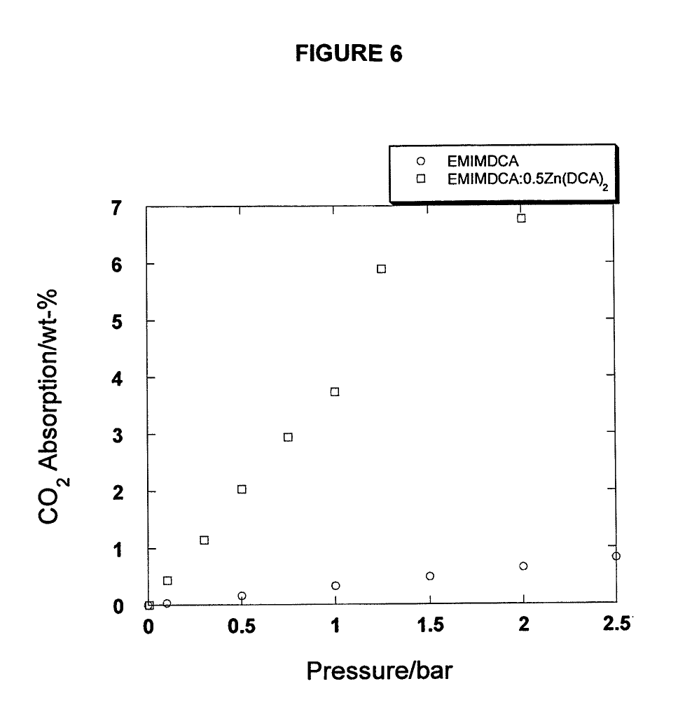

FIG. 6 shows the effect of the metal species on the CO₂ absorption capacity in the ionic liquid [EMIM][DCA]. Adding 11.8 wt % Zn²⁺ increases the CO₂ absorption capacity from 0.33 wt % in the pure [EMIM][DCA] to 3.7 wt % at 1 bar, 40° C.

### Example 4

### [C₄mpyrr][TFSI] Containing Zn²⁺

Preparation of Zinc (II) containing IL [C₄mpyrr][TFSI]-Zn(TFSI)₂ (1:1 mol:mol)

Under an argon atmosphere, to an RBF containing N-methyl-N-butyl pyrrolidinium bis(trifluoromethanesulfonyl)imide (0.313 g, 0.80 mmol) was added anhydrous zinc bis(trifluoromethanesulfonyl)imide (0.500 g, 0.80 mmol). The mixture was stirred at 70° C. for 6 h, after which the white powder of Zn(TFSI)₂ was fully dissolved in the ionic liquid, resulting in a transparent oil.

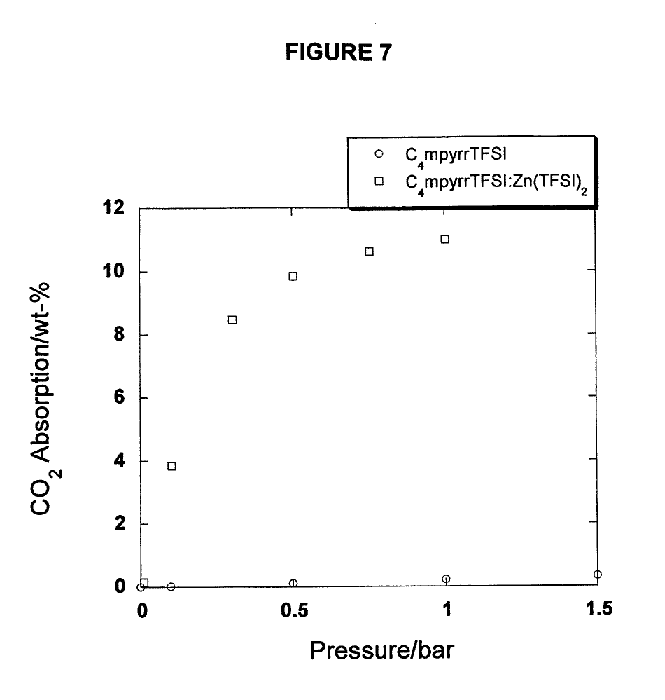

FIG. 7 shows the effect of the metal species on the CO₂ absorption capacity in the ionic liquid [C₄mpyrr][TFSI]. Adding 6.2 wt % Zn²⁺ increases the CO₂ absorption capacity from 0.22 wt % of the pure [C₄mpyrr][TFSI] to 11 wt % at 1 bar, 40° C., an increase of 50 times.

### Example 5

### Desorption

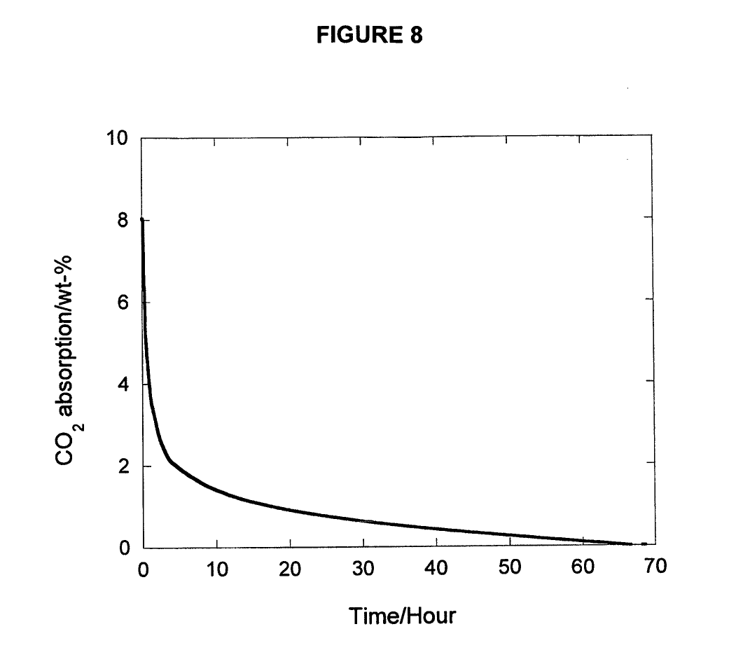

The desorption is carried out by raising the temperature in a temperature swing procedure. It was observed for all the systems studied in this invention that, when there is no phase transition occurs, the absorption capacity decreases while the temperature increases. This indicates that the CO₂ absorption is an exothermic process. For example, [EMIM][TFSI]-Zn(TFSI)₂ (1:1 mol:mol) displays a decreased CO₂ absorption with temperature, as shown in FIG. 2. The absorbed CO₂ is removed at a higher temperature by a temperature swing procedure. An example of the desorption process for [EMIM][TFSI]:Zn(TFSI)₂ at a higher temperature (77° C.) and a lower CO₂ partial pressure (8 mbar) is shown in FIG. 8. The absorbed CO₂ is gradually removed with time.

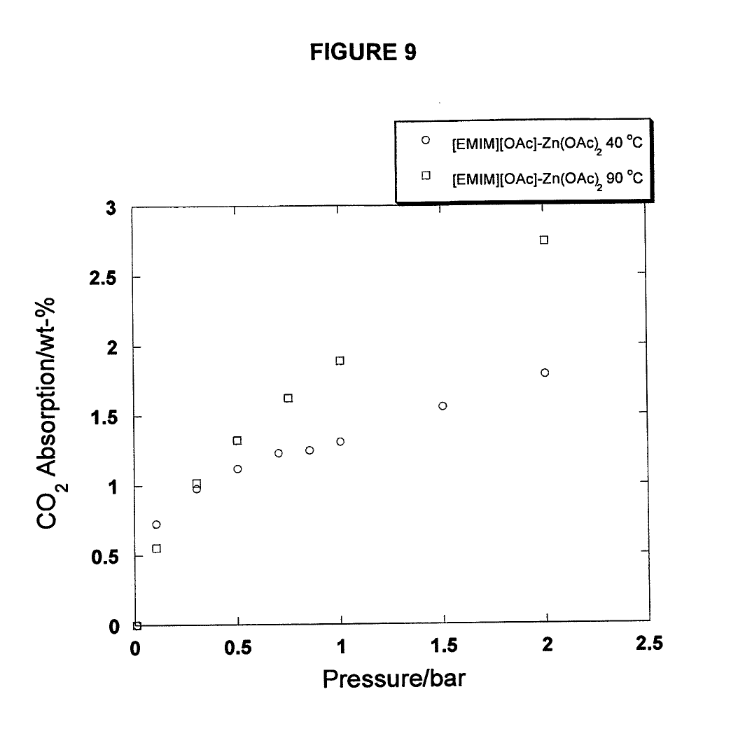

For some ionic liquids which exhibit phase transition(s) in the temperature range of a temperature swing procedure, a higher CO₂ absorption capacity may be observed in a high-temperature phase. For example, the ionic liquid [EMIM][OAc]-Zn(OAc)₂ (1:1 mol:mol) has a melting point at 77° C. It shows a higher absorption capacity at 90° C. than at 40° C., as displayed in FIG. 9. Therefore, a desorption can occur by cooling the ionic liquids.

### Example 6

### Liquidus Temperature of Ionic Liquids

The liquidus temperature of an ionic liquid is between the melting point (or glass transition temperature) and the decomposition temperature. The melting point and glass transition temperature were measured by a TA Differential Scanning calorimeter (DSC) 2910. About 10 mg of sample was sealed in an Al hermetic pan. The samples were cooled by liquid nitrogen at 10˜20° C. min⁻¹ to −150° C. The DSC traces were recorded during heating at 10° C. min⁻¹.

The decomposition temperature was measured by a TA Thermal Gravimetric Analysis (TGA) 2050. About 10 mg of sample was loaded on an Al pan. The sample weights were recorded during heating at 10° C. min⁻¹. The decomposition temperature can also be recognised by DSC measurement.

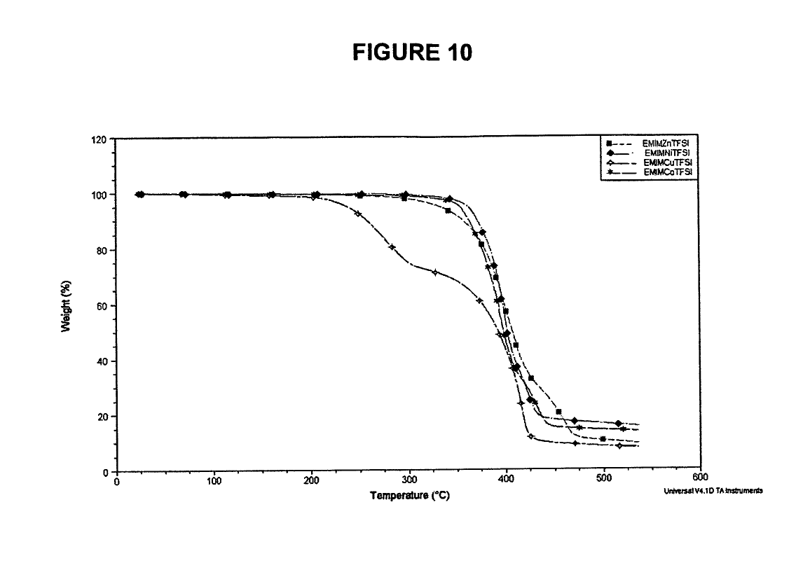

The liquidus temperatures and decomposition temperatures of the ionic liquids are listed in Table 1. FIG. 10 shows the thermal stability of some example ILs. The decomposition temperatures for [EMIM][EMIM][TFSI]-Co(TFSI)₂ (1:1 mol:mol), [EMIM][TFSI]-Ni(TFSI)₂ (1:1 mol:mol), [EMIM][TFSI]-Cu(TFSI)₂ (1:1 mol:mol) and [EMIM][TFSI-Zn(TFSI)₂ (1:1 mol:mol) are 352° C., 379° C., 195° C. and 355° C., respectively.

TABLE 1
Liquidus temperatures (T_{liq}) and decomposition temperatures
(T_{decomp}) of ionic liquids containing metal species.

| Ionic Liquid | T_{liq} (° C.) | T_{decomp} (° C.) |
|---|---|---|
| Zn(TFSI)₂-[EMIM][TFSI] | −43.1^{a} | 355 |
| Co(TFSI)₂-[EMIM][TFSI] | −36.0^{a} | 352 |
| Cu(TFSI)₂-[EMIM][TFSI] | −52.2^{a} | 195 |
| Ni(TFSI)₂-[EMIM][TFSI] | −21.3^{b} | 379 |
| 0.5Cd(TFSI)₂-[EMIM][TFSI] | 44.9^{b} | 407 |
| 0.3Mn(TFSI)₂-[EMIM][TFSI] | −71.0^{a} | 410 |
| 0.5Fe(TFSI)₂-[EMIM][TFSI] | −57.4^{a} | 372 |
| 0.75Mg(TFSI)₂-[EMIM][TFSI] | −47.9^{a} | 353 |
| Al(TFSI)₃-[EMIM][TFSI] | −63.8^{a} | 92 |
| 0.5Zn(DCA)₂-[EMIM][DCA] | −65.7^{a} | 134^{c} |
| Zn(TFSI)₂-[P14][TFSI] | −43.5^{a} | 325 |
| Zn(OAc)₂-[EMIM][OAc] | 77.4 | 223 |

^{a}glass transition temperature;
^{b}melting point;
^{c}irreversible solidification temperature

1-39. (canceled)

40. A process for the absorption of one or more gas(es) selected from the group consisting of carbon dioxide, hydrogen sulfide, sulfur oxides, nitrogen oxides and carbon monoxide from a fluid, the process including:
providing
a fluid containing the selected gas(es); and
an ionic liquid absorbent, the absorbent including the components:
one or more anions;
one or more metal species; and optionally
one or more organic cations; and optionally
one or more ligands;
the absorbent components being selected such that the absorbent is in a liquid state at the operating temperature and pressure of the process;
with the provisos that:
when the anion contains in the same molecular entity: both an amine functional group and a sulfonate functional group; both an amine functional group and a carboxylate functional group; both a phosphine functional group and a sulfonate functional group; or both a phosphine functional group and a carboxylate functional group, the metal species is not an alkali metal or alkaline earth metal;
the anion and/or metal species do not form a cuprate; and
when the anion and/or metal species form a metal halide, the ionic liquid absorbent includes one or more ligands;
contacting the fluid with the ionic liquid absorbent such that the selected gas(es) interact with the metal species; and
collecting an ionic liquid in which at least a portion of the selected gas(es) is absorbed.

41. A process according to claim 40, wherein the anion is selected from the group consisting of substituted amides; substituted imides, stable carbanions; hexahalophosphates; tetrahaloborates; halides; cyanate; isocyanate; thiocyanate; inorganic nitrates; organic nitrates; nitrites; oxysulfur species; sulfonates; oxyphosphorus species; optionally substituted and/or halogenated alkyl phosphate mono-, di- and triesters; optionally substituted and/or halogenated aryl phosphate mono-, di- and triesters; mixed substituted phosphate di- and triesters; optionally substituted and/or halogenated alkyl phosphates; optionally substituted and/or halogenated aryl phosphates; halogen, alkyl or aryl mixed substituted phosphates; carboxylates; carbonates; silicates; organosilicates; borates, alkyl boranes; aryl boranes; deprotonated acidic heterocyclic compounds; alkyloxy compounds; aryloxy compounds; alpha to omega diketonates; alpha to omega acetylketonates; and complex metal ions.

42. A process according to claim 41, wherein the one or more metal species is selected from the group consisting of 3d-transition metals, 4d-transition metals, 5d-transition metals, 2a main-group metals and 3a main-group metals.

43. A process according to claim 40, wherein the metal species is dissolved in the ionic liquid absorbent or is suspended or dispersed in the ionic liquid absorbent.

44. A process according to claim 40, wherein the ionic liquid absorbent includes one or more organic cations.

45. A process according to claim 44, wherein the organic cation is selected from the group consisting of boronium (R₂L′L″B⁺), carbocation (R₃C⁺), amidinium (RC(NR₂)₂⁺), guanidinium (C(NR₂)₃⁺), silylium (R₃Si⁺), ammonium (R₄N⁺), oxonium (R₃O⁺), phosphonium (R₄P⁺), arsonium (R₄As⁺), antimonium (R₄Sb⁺), sulfonium (R₃S⁺), selenonium (R₃Se⁺), iodonium (IR₂⁺) cations, and their substituted derivatives, wherein
R is independently selected from the group consisting of Y, YO—, YS—, Y₂N— or halogen;
Y is a monovalent organic radical or H; and
L′ and L″ are ligands that may be identical or different, wherein L′ and L″ possess a net overall charge of zero.

46. A process according to claim 45, wherein when Y is a monovalent organic radical, the organic cation includes a second monovalent organic radical so as to form a ring system including a centre of formal positive charge.

47. A process according to claim 44, wherein the organic cation is a saturated or unsaturated cyclic or non-cyclic cation, optionally containing one or more heteroatoms.

48. A process according to claim 47, wherein the organic cation is:
an unsaturated heterocyclic cation selected from the group consisting of substituted and unsubstituted pyridiniums (C₅R₆N⁺), pyridaziniums, pyrimidiniums, pyraziniums, imidazoliums (C₃R₅N₂⁺), pyrazoliums, thiazoliums, triazoliums (C₂R₄N₃⁺), oxazoliums, and substituted and unsubstituted multi-ring system equivalents; or
a saturated heterocyclic cation selected from the group selected from the group consisting of substituted and unsubstituted pyrrolidinium, piperidiniums, piperaziniums, morpholiniums, azepaniums, imidazoliniums (C₃R₇N₂⁺), and substituted and unsubstituted multi-ring system equivalents thereof.

49. A process according to claim 40, wherein the ionic liquid absorbent includes one or more ligands.

50. A process according to claim 40, wherein the selected gas is carbon dioxide.

51. A process according to claim 40, wherein the interaction between the selected gas(es) and the metal species is the primary mechanism for the absorption of the selected gas(es).

52. A process for the desorption of gas from an ionic liquid in which one or more gas(es) selected from the group consisting of carbon dioxide, hydrogen sulfide, sulfur oxides, nitrogen oxides and carbon monoxide are absorbed, the process including:
providing an ionic liquid absorbent in which the one or more selected gas(es) are absorbed;
treating the ionic liquid absorbent in which the selected gas(es) are absorbed, such that the gas is released; and
collecting the released gas;
wherein the ionic liquid absorbent including the components:
one or more anions;
one or more metal species; and optionally
one or more organic cations; and optionally
one or more ligands;
the absorbent components being selected such that the absorbent is in a liquid state at the operating temperature and pressure of the process.
with the provisos that:
when the anion contains in the same molecular entity: both an amine functional group and a sulfonate functional group; both an amine functional group and a carboxylate functional group; both a phosphine functional group and a sulfonate functional group; or both a phosphine functional group and a carboxylate functional group, the metal species is not an alkali metal or alkaline earth metal;
the anion and/or metal species do not form a cuprate; and
when the anion and/or metal species form a metal halide, the ionic liquid absorbent includes one or more ligands.

53. A process according to claim 52, wherein the anion is selected from the group consisting of substituted amides; substituted imides, stable carbanions; hexahalophosphates; tetrahaloborates; halides; cyanate; isocyanate; thiocyanate; inorganic nitrates; organic nitrates; nitrites; oxysulfur species; sulfonates; oxyphosphorus species; optionally substituted and/or halogenated alkyl phosphate mono-, di- and triesters; optionally substituted and/or halogenated aryl phosphate mono-, di- and triesters; mixed substituted phosphate di- and triesters; optionally substituted and/or halogenated alkyl phosphates; optionally substituted and/or halogenated aryl phosphates; halogen, alkyl or aryl mixed substituted phosphates; carboxylates; carbonates; silicates; organosilicates; borates, alkyl boranes; aryl boranes; deprotonated acidic heterocyclic compounds; alkyloxy compounds; aryloxy compounds; alpha to omega diketonates; alpha to omega acetylketonates; and complex metal ions.

54. A process according to claim 52, wherein the one or more metal species is selected from the group consisting of 3d-transition metals, 4d-transition metals, 5d-transition metals, 2a main-group metals and 3a main-group metals.

55. A process according to claim 52, wherein the metal species is dissolved in the ionic liquid absorbent or is suspended or dispersed in the ionic liquid absorbent.

56. A process according to claim 52, wherein the ionic liquid absorbent includes one or more organic cations.

57. A process according to claim 56, wherein the organic cation is selected from the group consisting of boronium (R₂L′L″B⁺), carbocation (R₃C⁺), amidinium (RC(NR₂)₂⁺), guanidinium (C(NR₂)₃⁺), silylium (R₃Si⁺), ammonium (R₄N⁺), oxonium (R₃O⁺), phosphonium (R₄P⁺), arsonium (R₄As⁺), antimonium (R₄Sb⁺), sulfonium (R₃S⁺), selenonium (R₃Se⁺), iodonium (IR₂⁺) cations, and their substituted derivatives, wherein
R is independently selected from the group consisting of Y, YO—, YS—, Y₂N— or halogen;
Y is a monovalent organic radical or H; and
L′ and L″ are ligands that may be identical or different, wherein L′ and L″ possess a net overall charge of zero.

58. A process according to claim 57, wherein when Y is a monovalent organic radical, the organic cation includes a second monovalent organic radical so as to form a ring system including a centre of formal positive charge.

59. A process according to claim 56, wherein the organic cation is a saturated or unsaturated cyclic or non-cyclic cation, optionally containing one or more heteroatoms.

60. A process according to claim 57, wherein the organic cation is:
an unsaturated heterocyclic cation selected from the group consisting of substituted and unsubstituted pyridiniums (C₅R₆N⁺), pyridaziniums, pyrimidiniums, pyraziniums, imidazoliums (C₃R₅N₂⁺), pyrazoliums, thiazoliums, triazoliums (C₂R₄N₃⁺), oxazoliums, and substituted and unsubstituted multi-ring system equivalents; or
a saturated heterocyclic cation selected from the group selected from the group consisting of substituted and unsubstituted pyrrolidinium, piperidiniums, piperaziniums, morpholiniums, azepaniums, imidazoliniums (C₃R₇N₂⁺), and substituted and unsubstituted multi-ring system equivalents thereof.

61. A process according to claim 52, wherein the ionic liquid absorbent includes one or more ligands.

62. A process according to claim 52, wherein the selected gas is carbon dioxide.

63. A process according to claim 52, wherein the desorption of the selected gas(es) is effected by an electrochemical process, or by cooling the ionic liquid in which the one or more selected gas(es) is absorbed.
